(19) United States
(12) Patent Application Publication
(10) Pub. No.: US 2006/0042224 A1
(43) Pub. Date: Mar. 2, 2006

(54) Dual-plasma jet thruster with fuel cell

(75) Inventors: James ShihFu Shiao, Stow, OH (US); Albert Shih Yung Shiao, Stow, OH (US)

Correspondence Address: Law Offices of John D. Gugliotta, PE, Esq., 202 Delaware Building, 137 South Main Street, Akron, OH, 44308, US

(73) Assignee: Daw Shien Scientific Research & Development, Inc.

(21) Appl. No.: 10/929,023

(22) Filed: Aug. 30, 2004

(51) Int. Cl. F03H 1/00

(52) U.S. Cl. 60/203.1; 60/204

(57) ABSTRACT

New [GerTh. I] & [DawShien. II] dual-plasma jet thrusters provide the electric start system to start their warm-up processes, automatically. After their warm-up processes done and the operation temperatures reached, the [GerTh. I] & [DawShien. II] dual-plasma jet thrusters will run through themselves, independently by continuously supplying fuels and moisture into the units. Electrical power will be generated from the only [GerTh. I] jet thruster's fuel cell ([GOD, I] fuel cell) by thermal-plasmas reaction and then, its [GOD, I] fuel cell's fuel supplies are transformed from molecular forms into atomized and ionized forms by plasmas combustion heating, stepwise. When dual plasmas are ejected through the ‘C’ shaped magnet's opening sides, linear thrust is generated according to the right hand rule. Thereafter, the combustion and neutralization are conducted also with the same electric thrust direction for propelling the object in the same linear guided motion.

### BACKGROUND OF THE INVENTION

1. Field of the Invention

The present invention relates generally to thermal-plasmas generation methods for power and, more particularly to a method of generating useful linear thrust with utilizing dual-plasma, positively and negatively charge-coupled plasmas which are passed through the latitudinal open end from opposite sides of a “C” shaped magnet, according to the right-hand rule, and combusted and neutralized in the combustion space thereafter to sustain their next processing cycle's heat and power demands.

2. Background of the Invention

In recent years, the conventional single plasma thrusters have generated a limited current density with a slower jerky motion which results in the lower efficiency and requires more physical space. The dual-plasma thruster's (electro-thermal-chemical) process provides improvements and advantages over conventional thruster's problems of relating to the slow conversion of heat and chemical energy into electromagnetic power with difficult jerky displacement.

A search of the prior art did not disclose any patent that reads directly on the claims of the present invention; however, the following references were considered relating and relevant to the present invention:
U.S. Pat. Nos. 6,029,438 and 6,182,441, each issued in the name of Hosick, discloses a drive circuit for electric propulsion thruster;
U.S. Pat. No. 6,293,090, issued in the name of Olson, discloses a radio frequency plasma thruster for use in electric propulsion spacecraft, the thruster heating single-plasma in a magnetic field and producing axial thrust, not greatly increasing the efficiency of the RF plasma thruster compared to other thrusters;
U.S. Pat. No. 6,478,257, issued in the name of Oh et al., discloses a phase change material such as HDPE to have heater or thermal control for electric propulsion devices (thrusters);
U.S. Pat. No. 6,541,916, issued in the name of Decker, discloses a method and circuit for providing power distribution to electric propulsion thrusters;
U.S. Pat. No. 6,609,363, issued in the name of Dressler et al., discloses single-iodine-plasma electric propulsion thrusters, wherein a heated tank containing iodine crystals is converted into a gaseous propellant;
U.S. Pat. No. 6,660,417, issued in the name of Nishio et al., discloses a fuel cell that generates electricity using hydrogen, an electrolytic device that electrolyzes water using electricity from an external electricity system, a hydrogen storage device that stores hydrogen and then supplies the stored hydrogen to the fuel cell, a heat supplying device and a driving controller that drives the fuel cell so as to generate electricity during a first time period and drives the electrolytic device so as to electrolyze water during a second time period;
U.S. Pat. No. 6,651,597, issued in the name of Daniel et al., discloses a plasmatron having an air jacket, the plasmatron reforming hydrocarbon fuels so as to produce reformed gas further supplied to a remote device such as an internal combustion engine or fuel cell;
U.S. Patent Application Publication No. 2001/0026893 A1, filed under the name of Asukabe et al., discloses a grafted polymer electrolyte membrane for use in a proton-exchange membrane fuel cell or for electrolysis of water;
U.S. Patent Application Publication No. 2003/0224232 A1, filed under the name of Browall et al., discloses a method for manufacturing a fuel cell assembly;
U.S. Patent Application Publication No. 2004/0001993 A1, filed under the name of Kinkelaar et al., discloses a gas diffusion layer for fuel cells formed from a porous material comprising a solid matrix and interconnected pores having at least one external surface and internal surface, and wherein the external surface is coated with one or more layers of at least one electrically conductive material;
U.S. Patent Application Publication No. 2004/0018416 μl, filed under the name of Choi et al., discloses carbon nanotubes for fuel cells doped with nano-sized metallic catalyst particles;
U.S. Patent Application Publication No. 2004/0033411 A1, filed under the name of Lersch et al., discloses a fuel cell module comprising a magnetic shielding;
U.S. Patent Application Publication No. 2004/0028962 A1, filed under the name of Stolten et al., discloses a fuel cell stack with circuit; and
U.S. Patent Application Publication No. 2004/0030469 μl, filed under the name of MacBain, discloses a method and control system for controlling propulsion in a hybrid vehicle.

### SUMMARY OF THE INVENTION

It is the present invention to utilize dual-plasma streams, one of a positive charge and one of a negative charge, in which the streams are thermal-energized and run against each other from opposite sides along the latitudinal opening of the C-shaped magnet, thereby generating linear electromagnetic movement according to the right hand rule.

An advantage of the present invention is that a higher thrust and higher current density of dual-plasma can be achieved, and therefore less physical space being needed.

Another advantage of the present invention is its scalability.

Yet another advantage of the present invention is the inclusion of an electric start system for providing a “warm-up” process for this unit. Before this unit is self-sustaining in replenishing the fuel, humidity, and oxygen, battery's power is provided to charge the plasmas and ignition system for generation of plasmas and thrust through a “C” shaped magnet.

Yet another advantage of the present invention is with no moving parts, thus no parts are subject to conventional wear and tear of standard combustion and gas-turbine engines. Therefore, the present invention is a durable device requiring minimal maintenance and minimal down-time for maintenance and/or repair.

Yet another advantage of the present invention is the high current density of dual-plasma generated by this unit's fuel cell ([GOD, I] fuel cell) in comparison to conventional fuel cells, thereby increasing and enhancing efficiency over the conventional fuel cells.

Yet another advantage of the present invention is the higher flame operation temperature range (2200° C.-3000° C.) at which the dual-plasma jet thruster's fuel cell operates, thereby generating the higher voltage and amperage, and further generating greater power than conventional fuel cells do.

In one innovation of the present invention, a new dual-plasma jet thruster having a “C-shaped” magnet for generating thrusting force is provided to generate a linear motion for use in automobiles (car, truck, bus), train, ship, airplane, space craft or other mobile craft for pushing them upward or forward.

Electrical power is needed for starting this [GerTh. I] jet thruster's fuel cell ([GOD, I] fuel cell) process by a spared battery and then, the initial fuel supplies are transformed from a molecular forms into atomized and ionized forms of the generation of positively and negatively charged plasma streams by previously battery-charged-plasmas' combustion heating. The next-cycle's plasma streams are pressed, attracted to each other, and sucked out of chambers and then, ejected into from opposite sides through the latitudinal opening end of the “C” shaped magnet generating the thrust according to the right hand rule. And then, combustion and neutralization are conducted also with the same thrust direction for propelling the object in the same and enhancing guided linear motion and sustain its fuel cell's heating demands for the next thermal-plasmas generation cycle of normal operation process.

### DESCRIPTION OF THE PREFERRED INNOVATIONS

The advantages and the present invention will become better understood with referencing to the following more detailed descriptions and claims taken in conjunction with the accompanying drawings, in which like elements are identified with like symbols, and in which:

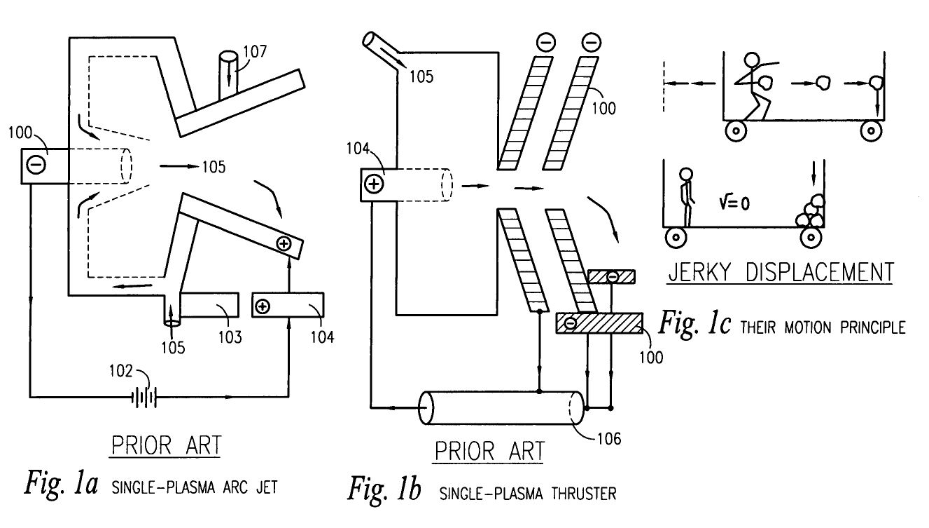

FIG. 1a is a schematic diagram of a conventional single (one) plasma arc jet according to the PRIOR ART;

FIG. 1b is a schematic diagram of a conventional single (one) plasma thruster according to the PRIOR ART;

FIG. 1c is a schematic illustration of the slowing abrupt (jerky) motion of a stationary car relative to balls thrown against a wall of throwing-catching effect within the same body;

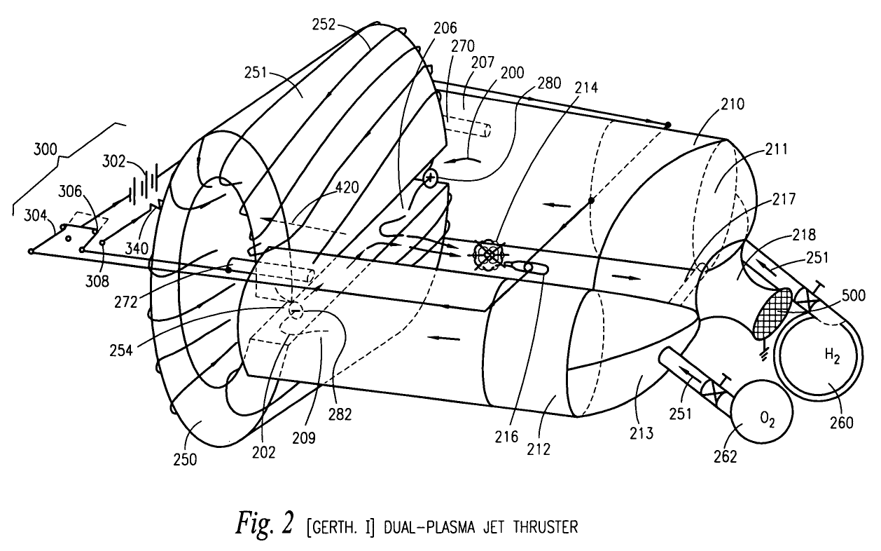

FIG. 2 is a schematic diagram of the First [GerTh. I] dual-plasma jet thruster (referred to as Thruster I) including an electric starter means; and

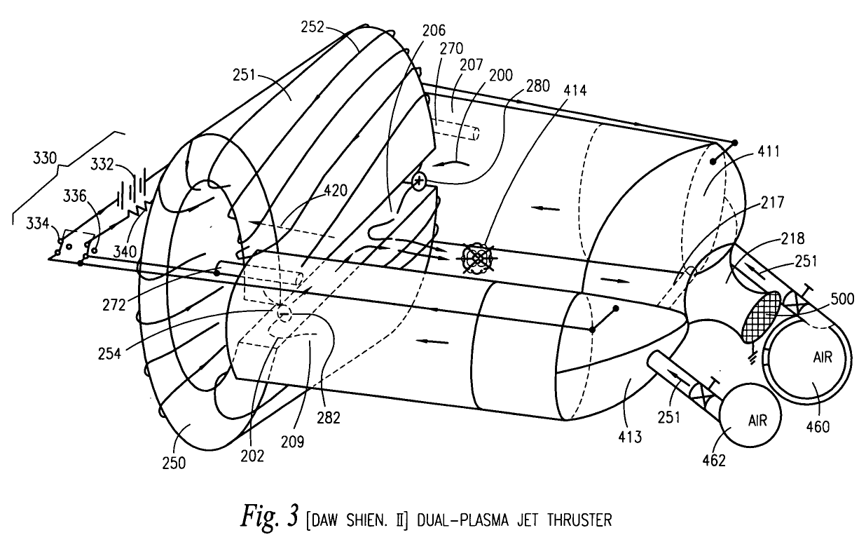

FIG. 3 is a schematic diagram of the Second electrified [DawShien. II] dual-plasma jet thruster (referred to as Thruster II) with utilizing saturated, humid air as plasmas source according to an alternate-plasmas innovation of the present thruster 1's invention.

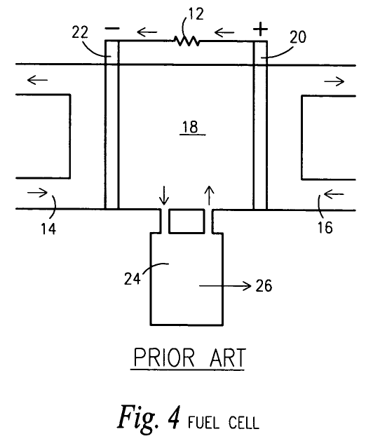

FIG. 4 is a schematic diagram of a conventional hydrogen-oxygen fuel cell according to the PRIOR ART;

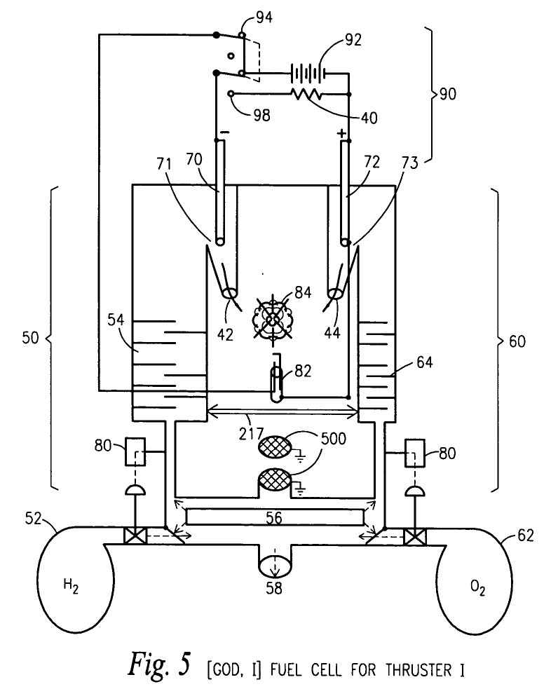

FIG. 5 is a schematic diagram of a first dual-plasma Jet thruster's (referred to as Thruster I's) hydrogen-oxygen fuel cell ([GOD, I] fuel cell) according to the present invention;

### DESCRIPTION OF THE PREFERRED INNOVATIONS

The best mode for describing the invention is presented in terms of its preferred innovations, herein depicted within the FIGS. 1 through 5.

1. Detailed Description of the Figures

Referring now to FIG. 1a and FIG. 1b, the conventional single-plasma arc jet and the plasma thruster according to the PRIOR ART are shown here, which broadly describe the principle of generation of thrust when an electrical source is connected through a cathode 100, from a battery 102 and electrons transferred to a charge receiver 105, anticipated as propellants, and passed through a magnetic field 103, and then propellants are neutralized at an electron acceptor 104, anticipated as an anode, and the coolant 107 cooled down the temperature of neutralization such as to generate little thrust in any manner in the prior art. Alternatively, as depicted in FIG. 1b, the cathode 100 and anode 104 are reversely set up from those of FIG. 1a, and has an electric power generator 106 as a substitute for the battery 102 of FIG. 1a. The acceleration interaction of this FIG. 1b plasma thruster's electrical field generated through the battery for the ionized single-plasma 105 accelerating from the anode 104 to the cathodes 100 generates little thrust force as in the prior art. Further, those electric single-plasma processes of charging and neutralizing are batch processes, generating a jerky motion and a short displacement. By analogy as shown in conjunction with FIG. 1c, this process is similar to throwing a ball against a car wall in order to impart force and motion onto the car. This will result in an abrupt perky), forward-backward, force and motion that are generated in the throwing-catching process within the same body and will ultimately lead to little linear displacement.

FIG. 2, An ignition circuit, generally denoted as 300, for warming-up a [GerTh. I] dual-plasma jet thruster's fuel cell ([GOD, I] fuel cell), is provided in which a battery 302 provides any needed initial current flow that is required to initiate the positive plasma stream 200 and negative plasma stream 202 at the warm up process. An interlock switch 304 allows for transition, as an electron donor source, from the battery 302 to ignite the continued plasmas combustion stream. After high temperature is attained such that the other generation of current flow is sustained no more by the battery 302, but by the generation of next new plasmas 200 and 202 from the previous thermal combustion heat 214 of the previous dual positively and negatively charged plasmas 207 and 209. An operation switch 308 is provided for separate disengagement and engagement of cable coil 252 wound about the C-shaped magnet 250 to enhance its electromagnetic field, each described in further detail below. After an initial “warm-up” process, in which the unit is permitted to reach and sustain sufficient operating temperatures, ensures consistent replenishment of the plasmas, the interlock switch 304 is placed in an “off” position and the operation switch 308 is placed in an “on” position. By selectively placing the operation switch 308 in the “on” position, the cable coil 252 is engaged and used to conduct electricity and enhance the electromagnetic field 206 of the magnet 250. Thus, when the sufficient operating temperature is attained, plasmas generation and usage are consistent and electricity is automatically generated from the thruster's fuel cell through a continuous supply of humid fuel 260 and oxygen 262. As such, the unit will generate consistent electromagnetic force (thrust) by using plasmas passed through the “C” shaped electromagnet 250 according to the right hand rule generating thrust to push or propel an object in a powerful linear motion.

FIG. 2 shows the general design of a schematic diagram of a [GerTh. I] dual-plasma jet thruster (Thruster I) in which the dual plasmas are provided by a positive plasma stream 200 and an electron receiver 202 (provided by a negative plasma stream) through the cable as connected to fuel cell's electrodes. Then dual plasmas are passed through a C-shaped opening end of the magnet 250 (and magnetic field 206) vertically from opposite sides to generate an action force 214 according to the right-hand rule. The positive plasma stream 200 is provided by a flow of ionized positive plasma, such as ionized humid hydrogen from the cathode, through a thermal-plasma reaction, in which that electrode is “negative” like that of a battery. The interaction of the electromagnetic field 206 of the “C” shaped magnet 250 with the ionized plasmas 200 and 202, which are pressurized, attracted to each other and sucked out from the positive plasma chamber 207 and negative plasma chamber 209 through the magnetic field 206 generates more thrust force 214 according to the right hand rule. The [GerTh. I] dual-plasma jet thruster will have more thrust with no jerky (abrupt) motion.

Other improvements in the generation of thrust in utilizing a dual positive and negative plasma streams are shown in which the neutralization and combustion of the positively charged plasma stream with the negatively charged plasma stream generate sparks and heat, in which the heat can be recycled through placing the atomization 210, 212 and ionization chambers 207, 209 along the sides for generating ionized plasmas in ionizing chambers 207, 209 along the combustion space, separately. By comparison of [GerTh. I] dual-plasma jet thrusters to the conventional single-plasma arc jet and the single-plasma thruster as shown in FIG. 1A and FIG. 1B, the generation of more thrust of this invention is got when an electron donor provided by a the positively charged plasma stream and an electron receiver provided by a negatively charged plasma stream through the thermal plasmas generation. When combined and combusted plasmas after their passing through the opening end of the C-shaped magnet, the generated thrust 420 is greater than in the prior art. The interaction between the magnetic field and the ionized plasmas ejected from the dual-plasma chambers 207, 209 generates an action force 214 and a reaction force 420 as in the right hand rule.

More specifically, FIG. 2 depicts a dual-plasma jet thruster's fuel cell comprising heat exchangers 211 and 213 coupled to the electric insulated 251 fuel storage tanks 260 and 262 which are supplying fuel 260 and oxygen 262 through humidity injected 217 to the thruster unit. Fuels are delivered from the electric insulated 251 tanks 260 and 262 to the chambers 210 and 212, through heat exchangers 211 and 213 and humidity injection 217 for atomization 210 and 212 and/ionization 207 and 209 of the fuel into plasma streams 200 and 202. In this innovation. The plasmas are humidity injected 217 hydrogen 260 and humidity injected 217 oxygen 262 for having better electric conductivities 270 & 272. Other gases such as humid air, humid Neon, and humid Argon can also be used as plasmas sources in the similar thrusters as in next FIG. 3. Electrodes 270 and 272 are provided within the ionizing chambers 207 and 209, which are at end opposite sides and are adjacent to the C-shaped magnet 250. The fuel storage tanks 260 and 262, are electrically well insulated 251. The electrodes 270 and 272 are charged to ionize molecules by a battery at the warm-up stage and are conducting electrons 340 generated by the thermal-plasmas reaction after the normal operation process begins 308. Ejection portals 280 and 282 are provided on the ionization chambers 207 and 209. The oppositely charged plasmas 200 and 202 are mutually attracted and bent closer toward each other through the magnetic field 206, thereby generating thrust according to the right hand rule. The combustion and neutralization processes occur at the ignition 216 and combustion space 214 of this unit. The high pressure combustion waste 214 generated by the unit is released through a nozzle 218 provided at a rear end of the unit, which acts similarly to an after-burner process for making-up more thrust.

The magnet 250 has cable coil 252 wound about the external surfaces to generate concurrent electromagnetic fields about the magnet 250. The cable 252 is oil cooled for extending the life of the unit and optimizing operating insulation conditions 251. The magnet 250 may include ceramic insulation 251 to protect and/or optimize the electromagnetic field generated by the cable coil 252. The grounding grids 500 are set up for astray charges and for public safety.

Referring now to FIG. 3, a schematic diagram of an electrified [DawShien. II] dual-plasma jet thruster (Thruster II) by utilizing saturated humid injected 217 air 460 and 462, is depicted in accordance to an alternate plasma innovation to the present Thruster I invention. In this plasma innovation, as compared to an exemplary innovation described by FIG. 2, moisture 217 saturated air 460 and 462 of alternate plasmas 200 and 202 are drawn into the Thruster II unit. The humid air is charged by a battery or static generator 332 and directed through a positive ionization chamber 207 and a negative ionization chamber 209, respectively. The battery or static generator 332 provides a continuous flow of charges to each ionization chamber 207, 209, within each is an electrode 270, 272, respectively. That provides contact between the electrically conductive metal and moisture saturated air, respectively. The electrodes 270 & 272 are metallic, such as gold, or steel/copper wool, or another suitable material shaped to have increased surface contact area. In this, the charged humid air flows 207 and 209 replace the positively charged hydrogen plasma and negatively charged oxygen plasma of FIG. 2, and are the very same passed through a “C” shaped magnet's 250 latitudinal opening 254, such that the interactions between the magnetic field and the ionized air ejected from the opposite dual-plasma chambers 207, 209 generate an action plasmas-bent force 414 and a reacting thrust force 420 according to the right hand rule of motor's, as in FIG. 3.

Finally, the [DawShien. II] dual-plasma jet Thruster's innovation as shown in FIG. 3 has a grounding grids 500 is provided for neutralizing the discharged stream 218 as a safety precaution to insure that any astray electrical charge is affirmatively neutralized in electric sparks 414 of the positive plasma stream 200 and negative plasma stream 202. The sparks' heat 414 and increased pressure are released from and directed through a nozzle 218 at the rear end of the unit, as in an after-burner to increase the thrust 420.

Referring now to FIG. 4, a schematic diagram of a conventional hydrogen-oxygen fuel cell according to the PRIOR ART is shown broadly describing the generation of electricity to support a load 12. The conventional fuel cell is a galvanic cell in which the chemical property of a fuel is converted directly into electricity by means of electrochemical processes. Fuel, in the form of hydrogen 14 and oxygen 16, are continuously and separately supplied to the two electrodes of the cell, anode 20 and cathode 22. The electrolyte 18 is also diluted by the water (chemical reaction product) and may be concentrated through the concentrator 24 and recycled back to the fuel cell. Waste water is discharged 26. This conventional hydrogen-oxygen-electrolyte process takes place in the lower temperature ranges of 40° C. to 50° C., but if at higher temperatures, a fuel cell runs the risk of electrolyte drought increased. The conventional hydrogen-oxygen-electrolyte fuel cell's electrochemical reactions are shown in the following equations:
Negative electrode: H₂ [symbol] 2H⁺+2e⁻+electrolyte
Positive electrode: ½O₂+2H⁺+2e⁻+electrolyte [symbol] H₂O

FIG. 5, For the new advanced thruster 1's fuel cell as ([GOD, I] Fuel Cell). For purposes of disclosure, and not as a limitation, and for purposes of providing a disclosure under 35 U.S.C. 112, the igniter/starter means 82/90 shall be described. As shown the flow streams 50, 60 are controlled through a throttling means 80, shown as an otherwise conventional pressure, temperature, and/or flow rate control means 80. Additionally, the heat generated from the ions combustion 84 can be used to heat the ionization processes 50, 60, during a warm-up process, or to ionize the respective gases in the atomization chambers 54, 64 and ionization chambers 71, & 73, through multiple baffles of the heat exchangers that form the respective atomization chambers 54, 64 and ionization chambers 71, & 73.

The remainder of the ignition circuit 82 is shown in which a battery 92 provides any needed initial current flow that is required to maintain the ionization of the positive plasma stream 42 and negative plasma stream 44, respectively.

FIG. 5 is provided for purposes of disclosing the new advanced [GOD, I] fuel cell of the method of generating useful power by utilizing dual-plasma 42, 44, positively and negatively charge-coupled plasmas through a cable 40 in which electrons are flowing from donor 42 to receptor 44 through thermal-energy-generating-plasmas reaction and loading the current through resistors 40 at the normal operation process.

FIG. 5 is a schematic diagram of a [GOD, I] dual-plasma hydrogen-oxygen fuel cell of thruster I's. According to the present invention, an electrical current is coming from plasmas generation 71 & 73 by thermal heating 84, and generates work across a load 40 through a cable 40 which is connected to a positively charged plasma stream 42 and to a negatively charged plasma stream 44 to complete an electrical ‘circuit’ at the normal operation process. The other part of this electrical circuit is through neutralization of dual-plasma occurring at the combustion and neutralization space 84. The positively charged plasma 42 is herein anticipated as hydrogen 50 with humidity addition 217, that is heated through an atomizing chamber 54 and ionization chamber 71, which will be described in greater detail below. The use of hydrogen 50 as an electron donor through cable 40 will require an atomization chamber 54 and an ionization chamber 71 of approximately twice the volume as for the electron receiver's 64, 73. Because two hydrogen ions neutralize the double charged oxygen ion, and hence the positive ionization chamber is larger than the negative ionization chamber (through the same pressure means).

The reaction equations for the negative electrode side are:
H₂+Heat [symbol] 2H;
2H+Heat+Cable [symbol] 2H⁺+2e⁻ (current flow)

The reaction equations for the positive electrode side are:
O₂+Heat [symbol] 2O;
2O+Heat+Cable+4e⁻(current flow) [symbol] 2O^{═}

For the Cable/Electrodes/Loads functions are:
−2e⁻ [symbol] 2e⁻ (electrons are flowing from the left to the right through loads)

The reaction equation for combustion and neutralization is:
2H⁺+O^{═} [symbol] Steam+Heat+Dynamic Electricity for Thruster I's Power

By pushing the positively charged plasma 42 across an electrode (cathode 70) and the negatively charged plasma stream 44 across another electrode (anode 72) through thermal-charge-split heating and higher pressure, the dual plasma streams are sucked out from ionization chambers 71, 73 by attraction force to each other. The dual-plasma streams 42, 44 can be combusted and neutralized 84 to complete the closed electrical circuit and generate heat 84 to sustain the ionization processes 50 & 60 and waste water 58 is discharged from a heat exchanger 56, which will be described in much detail below.

2. Operation of the Preferred Innovations

In accordance with the preferred innovations, the various features of the present invention are summarized in Table 1 below.

TABLE 1
The Differences Among [GOD, I] Fuel Cell; [GerTh. I] &
[DawShien. II] Jet Thrusters.

| | [GOD, I] Fuel | | [DawShien. |
|---|---|---|---|
| | Cell Thruster | [GerTh. I] | II] |
| Classification | I's fuel cell | [Thruster I.] | [Thruster II.] |
| Electric Start | Yes | Yes | Yes |
| Electric Running | No | No | Yes |
| Thermal Energy Run | Yes | Yes | No |
| Generate Electricity | Yes | Yes | No |
| Taken Electric Loads | Yes | Yes | Yes |
| With “C” shaped | No | Yes | Yes |
| Electromagnet | | | |
| Generate Motion | No | Yes | Yes |
| ‘+’ Plasmas | H⁺ (H₂O⁺) ion | H⁺ (H₂O⁺) ion | Sat. Air (+); |
| | | | Ne⁺; Ar⁺ |
| ‘−’ Plasmas | O⁼ (H₂O⁻) | O⁼ (H₂O⁻) ion | Sat. Air (−); |
| | ion | | Ne⁻; Ar⁻ |
| Neutralization | Yes | Yes | Yes |
| Grounding Grids | | | |

The foregoing descriptions of specific innovations of the present invention are presented for purposes of illustration and application. They are not intended to be exhaustive or to limit the invention to the precise forms disclosed, and obviously many modifications and variations are possible in light of the above disclosure. The innovations were chosen and described in order to best explain the motion principles of the dual-plasma jet thrusters and their practical applications, to thereby enabling others skilled in the art with various advanced modifications as those are suited to the particular use contemplatively. It is intended that the scope of the invention are defined by the claims appended hereto and their equivalents. Therefore, the scope of the invention is to be limited only by the following claims.

What claimed are:

1. A method for generating propulsion of an object comprising the steps of:
generating two plasma fuels in ionization chambers;
generating an electromagnetic action moving force by transporting said fuels through a ‘C’ shaped magnet; and
generating combustion and neutralization for propelling said object.

2. The method of claim 1, wherein said magnet comprises:
a C-shape having a latitudinal opening; and
a cable coil wound about said magnet coupled to an electrical source for enhancing the electromagnetic field about said latitudinal opening.

3. The jet thruster of claim 2, wherein said magnet is insulated by ceramic.

4. The method of claim 2, wherein said fuels are stored in separate insulated tanks.

5. The method of claim 2, wherein combustion generates an action force in the direction of the combustion discharge and a reaction force in the opposite direction, thereby enhances propelling said same object in the same direction of the reaction force.

6. The method of claim 1, wherein said plasmas pass through said ‘C’ shaped magnet such as to generate an action force in the direction of the plasmas discharge and neutralization and a reaction force in the opposite direction, thereby propelling said jet thruster in the direction of said reaction force.

7. The plasmas thrusters of claim 1 further comprising a grounding grid disposed posterior to said nozzle, said grid neutralizing excess astray electrical charges not previously neutralized for public safety precaution.

8. The methods of claim 1, wherein said methods are used for providing for the [GerTh. I] & [DawShien. II] dual-plasma jet thrusters.

9. The plasmas thrusters of claim 8, wherein said plasma fuel source appliance comprises a high-temperature humidity injector and generation for the saturated humid fuels for better electrical conduction.

10. The plasmas thrusters of claim 8, wherein said electrodes are made of gold, steel or copper wool to increase electric conducting surface.

11. The [DawShien. II] method of claim 8, wherein said air plasmas are alternatively generated by electrifying the saturated humid air via electrodes.

12. The [GOD, I] fuel cell (Thruster 1's fuel cell) comprising:
a fuel source having two ionizable fuels;
a pair of ionization chambers, each one of said chambers coupled to receive one of said plasma fuels, respectively;
a pair of ejection portals, each one of said portals depending from one of said ionization chambers;
a space disposed between said chambers for combustion of said fuels; and
a nozzle for discharging the combustion exhaustion;
the combustion of said ionized fuels generating thermal energy for heating said chambers and initializing the next plasmas-generation cycle.

13. The fuel cell of claim 12, wherein said fuel source comprises a pair of fuel tanks separately electrically well insulated.

14. The fuel cell of claim 12, wherein one of said plasma fuels is hydrogen saturated with water vapor, thereby allowing for easier electrical conducting.

15. The fuel cell of claim 12, wherein one of said plasma fuels is oxygen saturated with water vapor, thereby allowing for easier electrical conducting.

16. The fuel cell of claim 12, wherein said cable conducts electricity generated through said fuel cell capable of supporting an electrical load.

17. The fuel cell of claim 12 for use as in the Thruster I, just further equips one magnet disposed between said chambers of fuel cell, said magnet generating a magnetic field as for the Thruster I's uses;
a space disposed between said chambers and posterior to said magnet,
said space for combustion of said fuel; and
a nozzle for discharging combustion exhaustion and increasing thrust.

18. A method for fuel cell generation of an electrical current comprising the steps of:
delivering two fuels into ionization chambers;
ionizing said fuels by thermal-plasmas reaction within said chambers for generating electron flow and electricity passing through electrical loads;
transporting said fuels into a combustion and neutralizing space disposed between said chambers, said plasma fuels attracted to each other;
combusting said fuels for generating thermal energy;
said thermal energy heating said chambers for sustaining and ionizing said fuels in the next cycle.

19. The method of claim 18, wherein said combustion generates as a dynamic electrical current in conjunction with steam and heat.
